(19) United States
(12) Patent Application Publication
(10) Pub. No.: US 2016/0023616 A1
(43) Pub. Date: Jan. 28, 2016

(54) Self-Adjusting Base

(71) Applicant: Wojciech Kielpinski, Stanwood, WA (US)

(72) Inventor: Wojciech Kielpinski, Stanwood, WA (US)

(21) Appl. No.: 14/877,637

(22) Filed: Oct. 7, 2015

Related U.S. Application Data
(63) Continuation-in-part of application No. 13/899,493, filed on May 21, 2013, now abandoned.

(30) Foreign Application Priority Data
May 28, 2012 (PL) P.399346

(51) Int. Cl. B60R 11/00; B63B 17/00

(52) U.S. Cl. CPC B60R 11/00; B63B 17/00; B60R 2011/0084

(57) ABSTRACT

A self-adjusting base for a beverage container is disclosed. A circular flat base having a high-friction surface sits tiltably about an X-horizontal axis within a rigid ring that sits tiltably in a Y-horizontal axis, 90° offset, within the upper edge of a cylindrical mounting. Tilting is achieved by two pairs of pin-structures, each on diametrically opposed positions on the circular base and rigid ring, respectively, and engaging with horizontal cylinders located on the inner face of the upper edge of the cylindrical housing and rigid ring, respectively. Within the cylindrical housing is a quantity of liquid, and affixed to the circular flat base is a weight having a cylindrical shape with biased lateral walls whose lower edge hangs below the liquid level. A light source is located at the floor of the cylinder.

### CROSS-REFERENCE TO RELATED APPLICATIONS

This application is a continuation in part of copending U.S. patent application Ser. No. 13/899,493, filed on May 21, 2013, which claimed benefit of Polish Patent Application No. P.399346 filed in the Patent Office of the Republic of Poland on 28 May, 2012, also identified as WIPO ST 10/C PL 39946, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to beverage holder bases and in particular to beverage holder bases intended for use on watercraft and other unstable platforms. Users of watercraft, including both small boats and large ships, and including both commercial and recreational vessels often wish to consume beverages while aboard, however watercraft tend to heel and often cannot maintain a stable level relative to the Earth's gravity, and thus tend to tip in various directions, often unexpectedly. A beverage placed on a table or in a fixed beverage holder can easily spill when the vessel tips. This problem may be addressed by a beverage holder that self-adjusts to remain vertical relative to the Earth's gravity as the platform it rests on tilts. Such devices would be useful not only on watercraft, but also on other unstable platforms where users consume beverages.

Further, conventional fixed beverage holders accommodate only a limited size of container, namely, only those containers that have a circular footprint and are approximately the same diameter as the inner diameter of the beverage holder. A stable platform having a high-friction flat surface would permit any shape or size of beverage container up to the size of the platform to be supported against a watercraft's heel or other instability.

### SUMMARY OF THE INVENTION

Accordingly, a self-adjusting base for a beverage container is disclosed. A circular flat base having a high-friction surface sits tiltably about an X-horizontal axis within a rigid ring that sits tiltably in a Y-horizontal axis, 90° offset, within the upper edge of a cylindrical housing. Tilting is achieved by two pairs of pin-structures, each on diametrically opposed positions on the circular base and rigid ring, respectively, and engaging with horizontal cylinders located on the inner face of the upper edge of the cylindrical housing and rigid ring, respectively. Within the cylindrical housing is a quantity of liquid, and affixed to the circular flat base is a weight having a cylindrical shape with biased lateral walls whose lower edge hangs below the liquid level. A light source is located at the floor of the cylinder.

It is an object of the invention to provide a self-adjusting base for a beverage container that can keep the beverage container vertical against the heel of a watercraft or other unstable platform.

It is an object of the invention to provide a self-adjusting base for a beverage container that can provide a base for many shapes and sizes of beverage containers.

It is an object of the invention to provide a self-adjusting base for a beverage container having internal low lighting, thereby making it suitable for use in a low-light environment such as the bridge deck of a watercraft.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 shows a sectional side view of the first exemplary embodiment.

FIG. 2 shows a top view of the first exemplary embodiment.

FIG. 3 shows a close-up sectional side view of the hinge component of the first exemplary embodiment.

### DETAILED DESCRIPTION OF THE INVENTION

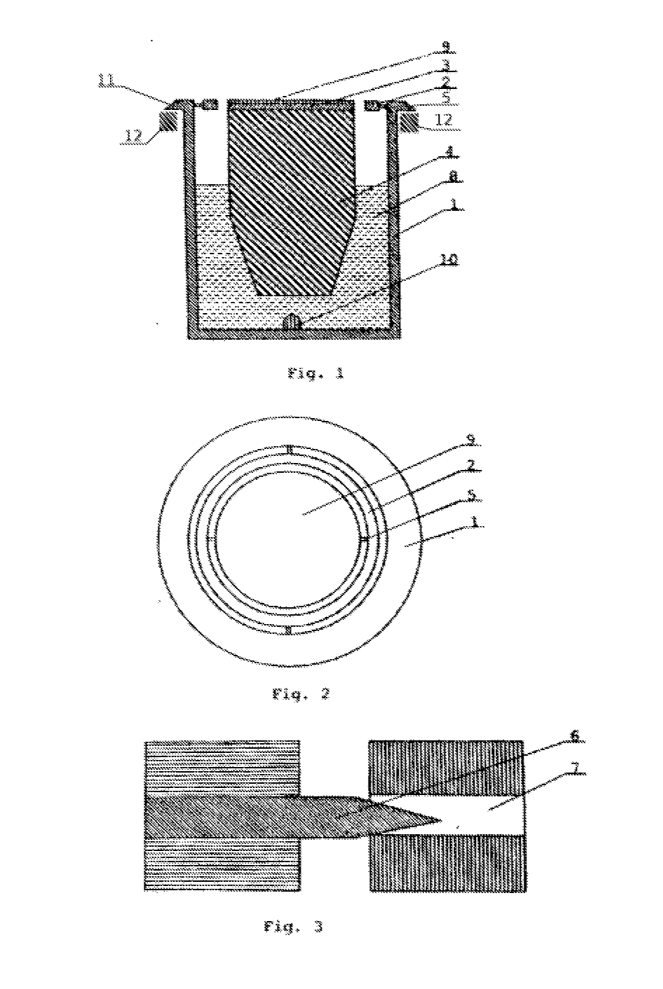

Referring now to the invention in more detail, the invention is directed to a self-adjusting base for a beverage container. FIG. 1 shows a sectional side view of the first exemplary embodiment. In the first exemplary embodiment, a cylindrical housing 1 features an external collar of increased diameter around its top edge making it suitable for mounting within a circular hole in a mounting surface such as a table or console of a watercraft. The housing 1 supports a light source 10 at its base and is filled with a liquid 8.

The light source 10 may be a light emitting diode may emit any of a variety of visible spectra. The light source 10 is preferably contained within a fluid-proof housing and may be powered by lead wires extending through the base of the housing 1 to a power source, which may be a battery or may be the electrical system of the watercraft or other location where the device is installed. The light source 10 may be configured to be “always on” in conjunction with its power source, or may be provided with an on/off switch at a location external to the housing 1.

FIG. 2 shows a top view of the first exemplary embodiment. In FIGS. 1 and 2, a circular flat base 3 having a top surface of anti-slip material 9 is suspended within an inner ring 2, which is suspended within the inner top edge of the cylindrical housing 1. The circular flat base 3 is supported by a first pair of specialized hinges 5 located at diametrically opposed points on the circumference of the circular flat base 3 and inner circumference of the inner ring 2. The inner ring 2 is supported by a second pair of specialized hinges 5 located at diametrically opposed points on the outer circumference of the inner ring 2 and on the inner circumference of the upper edge of the cylindrical housing 1. The first and second pairs of specialized hinges 5 are preferably offset 90° from one another in the horizontal plane to form an X-axis and Y-axis such that the circular flat base 3 may tilt about either access in order to remain vertical relative to the Earth's gravity. Affixed to the bottom surface of the circular flat base 3 is a weight 4, which is preferably shaped as a cylinder having biased lateral walls in the bottom portion. The weight 4's lower end preferably falls below the level of the liquid 8.

FIG. 3 shows a close-up cross section of the specialized hinges 5. Each hinge includes a tapered pin 6 positioned radially and preferably on the inner side of the hinge 5. The tapered pin 6 engages with an opposing cylindrical hole 7 of slightly larger diameter such that the tapered pin 6 and cylindrical hole 7 may freely rotate relative to each other about their common axial line.

The cylindrical housing 1, inner ring 2, circular flat base 3, hinge pins 6 and hinge cylindrical holes 7 are preferably made of a durable and rigid material such as high impact plastic or metal; the same components may be made optically transparent to permit additional emissions of the light source 10. The anti-slip material 9 may be made of a textured rubber or silicone material or any other flexible material having a high coefficient of friction with a broad range of beverage container materials. The weight 4 is may made of a dense material and may be rigid (e.g. steel) or may be granular or flexible and contained within a membrane (e.g. a flexible bladder container sand). The liquid 8 may be water or an alternative viscous fluid.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A self-adjusting base for a beverage container comprising:
(a) a cylindrical housing;
(b) an inner ring;
(c) a planar circular base;
(d) said inner ring being rotatably suspended within said cylindrical housing such that said inner ring may be freely rotated about a first horizontal axis such that said first horizontal axis passes through said planar circular base;
(e) said planar circular base being rotatably suspended within said inner ring such that said planar circular base may be freely rotated about a second horizontal axis;
(f) said second horizontal axis passing through said planar circular base;
(g) said second horizontal axis being non-parallel with said first horizontal axis;
(h) a solid weight; and
(i) said solid weight being affixed to the lower surface of said planar circular base;
whereby said cylindrical housing may be installed in a watercraft tending to heel and said circular base may remain vertical and a beverage container placed upon said circular base will be protected from spillage.

2. The self-adjusting base of claim 1 wherein said inner ring is suspending within said cylindrical housing by a first pair of hinges in alignment with said first horizontal axis, and wherein said planar circular base is suspended within said inner ring by a second pair of hinges in alignment with said second horizontal axis.

3. The self-adjusting base of claim 2 wherein each of said hinges comprises an axially aligned tapered pin engaged with an axially aligned cylindrical hole of a diameter larger than that of said tapered pin such that said axially aligned tapered pin may freely rotate within said axially aligned cylindrical hole.

4. The self-adjusting base of claim 1 wherein said cylindrical housing contains a liquid, the level of which is above the lower edge of said weight.

5. The self-adjusting base of claim 1 wherein the upper surface of said circular base is flat and is affixed to an anti-slip layer.

6. The self-adjusting base of claim 1 wherein said weight is shaped as a cylinder having biased lateral walls on its lower portion.

7. The self-adjusting base of claim 1 wherein said cylindrical housing is shaped so as to feature a collar around its upper edge.

8. The self-adjusting base of claim 1 further comprising a source of light; said source of light being located at the base of said cylindrical housing.

9. The self-adjusting base of claim 3 wherein said cylindrical housing contains a liquid, the level of which is above the lower edge of said weight.

10. The self-adjusting base of claim 3 wherein the upper surface of said circular base is flat and is affixed to an anti-slip layer.

11. The self-adjusting base of claim 3 wherein said weight is shaped as a cylinder having biased lateral walls on its lower portion.

12. The self-adjusting base of claim 3 wherein said cylindrical housing is shaped so as to feature a collar around its upper edge.

13. The self-adjusting base of claim 3 further comprising a source of light; said source of light being located at the base of said cylindrical housing.

14. The self-adjusting base of claim 9 wherein the upper surface of said circular base is flat and is affixed to an anti-slip layer.

15. The self-adjusting base of claim 9 wherein said weight is shaped as a cylinder having biased lateral walls on its lower portion.

16. The self-adjusting base of claim 9 wherein said cylindrical housing is shaped so as to feature a collar around its upper edge.

17. The self-adjusting base of claim 9 further comprising a source of light; said source of light being located at the base of said cylindrical housing.

18. The self-adjusting base of claim 14 wherein said weight is shaped as a cylinder having biased lateral walls on its lower portion.

19. The self-adjusting base of claim 14 further comprising a source of light; said source of light being located at the base of said cylindrical housing.

20. The self-adjusting base of claim 19 wherein said weight is shaped as a cylinder having biased lateral walls on its lower portion, and said cylindrical housing is shaped so as to feature a collar around its upper edge.
